(19) United States
(12) Patent Application Publication
(10) Pub. No.: US 2016/0150073 A1
(43) Pub. Date: May 26, 2016

(54) INTELLIGENT CONTENT RECOGNITION SYSTEM

(71) Applicant: International Business Machines Corporation, Armonk, NY (US)

(72) Inventors: Subil M. Abraham, Plano, TX (US); James P. Appleyard, North Richland Hills, TX (US); Pratik A. Naik, Dallas, TX (US)

(21) Appl. No.: 14/553,369

(22) Filed: Nov. 25, 2014

(51) Int. Cl. H04M 3/38; H04M 3/493

(52) U.S. Cl. CPC H04M 3/382; H04M 3/493

(57) ABSTRACT

Arrangements described herein relate to electronic communications and, more particularly, to the exchange of information over a telephonic communication channel. For example, during a telephone call session established over a telephonic communication channel between a user communicating using a first communication device and a customer service system, a content recognition system can receive media content or a digital signature, transmitted by the first communication device during the telephone call session. The media content or digital signature can be communicated over the telephonic communication channel used to support audio communication between the first communication device and the customer service system in the telephone call session. The digital signature can be processed to authenticate an identity of the user.

### BACKGROUND

The present invention relates to electronic communications and, more particularly, to the exchange of information over a telephonic communication channel.

In businesses, delivering a superior client experience is a key to building customer loyalty. To this end, businesses are investing heavily in their customer service centers to improve and streamline interaction between customers and the customer service centers. A large part of these interactions are still handled using voice communications over telephone lines.

Given the ever changing needs of customers, however, there still are high expectations of customer service centers using this mode of communication. These expectations are not always met. For example, just entering user information (e.g., a credit card number, a social security number, a password, etc.) over a voice channel can be tedious. Even with new technologies such as Voice over Internet Protocol (VoIP), customers oftentimes still are required to enter numbers and letters using a keypad.

In other cases, users are prompted to speak confidential information into a telephone, for example via an interactive voice response (IVR) system. This also can be tedious. IVR systems sometimes have difficulty understanding spoken utterances, especially if a user has a thick accent or a speech impediment. Moreover, a user may have concerns about speaking allowed their confidential information, especially when the user is contacting a customer service center when the user is in a public place; another person may overhear the confidential information and attempt to use the information for unscrupulous purposes.

Moreover, entering data to a customer service system, whether by selecting keys or providing spoken utterances, is time consuming. This can delay the process of reaching the proper customer service representative who is able to resolve the issue the customer is calling about.

### SUMMARY

A method can include receiving a digital signature over a telephonic communication channel. During a telephone call session established over a telephonic communication channel between a user communicating using a first communication device and a customer service system, a digital signature transmitted by the first communication device during the telephone call session can be received by a content recognition system executed by a processor. Thus, the user need not provide spoken utterances or multiple keystrokes for user authentication purposes.

The digital signature is communicated over the telephonic communication channel used to support audio communication between the first communication device and the customer service system in the telephone call session. In one arrangement, the audio communication between the user and the customer service system over the telephonic communication channel can occur in the telephone call session prior to and after the digital signature being transmitted. In one arrangement, the audio communication between the user and the customer service system can include audio communication between the user and an interactive voice response system. In another arrangement, the audio communication between the user and the customer service system can include audio communication between the user and a customer service representative. In one arrangement, the digital signature can include a credit card number. In another arrangement, in addition to or in lieu of the credit card number, the digital signature can include a social security number, a maiden name, a date of birth, a name that is different than the user's name and/or a password. Responsive receiving by the content recognition system the digital signature, the digital signature can be processed to authenticate an identity of the user.

Another method can include receiving media content over a telephonic communication channel. During a telephone call session established over a telephonic communication channel between a first user communicating using a first communication device and at least a second entity, media content transmitted by the first communication device over the telephonic communication channel during the telephone call session can be received by a content recognition system executed by a processor. Audio communication between the first user and the second entity can occur over the telephonic communication channel in the telephone call session prior to and after the media content being transmitted. Thus, the media content can be communicated from one user to another without disrupting voice communications in the call session. Responsive to receiving by the content recognition system the media content, at least one event can be initiated.

In one aspect, the second entity can be a second user. Further, initiating at least one event can include transmitting the media content to a second communication device used by the second user participating in a conference call with the first user. Further, the first communication device can communicate in the conference call using a first communication protocol and the second communication device can communicate in the conference call using a second communication protocol. The second communication protocol can be different than the first communication protocol. In an arrangement, a cloud storage can be provisioned to provide a transient workspace. The transient workspace can be configured to store the media content, and the transient workspace can be configured to be accessed by at least the second entity to retrieve the media content from the transient workspace over the telephonic communication channel. In an arrangement, initiating at least one event can include parsing information from the media content and processing the information parsed from the media content to authenticate an identity of the first user. The information parsed from the media content can include a social security number, a credit card number, a maiden name, a date of birth, and/or a name that is different than the user's name. In an arrangement, initiating at least one event can include parsing a credit card number from the media content and processing the credit card number parsed from the media content to process payment for an order for a product or service requested by the first user.

A system can include a processor programmed to initiate executable operations. In one aspect, the executable operations can include, during a telephone call session established over a telephonic communication channel between a user communicating using a first communication device and a customer service system, receiving by a content recognition system executed by the processor a digital signature transmitted by the first communication device during the telephone call session. Thus, the user need not provide spoken utterances or multiple keystrokes for user authentication purposes.

The digital signature is communicated over the telephonic communication channel used to support audio communication between the first communication device and the customer service system in the telephone call session. In one arrangement, the audio communication between the user and the customer service system over the telephonic communication channel can occur in the telephone call session prior to and after the digital signature being transmitted. In one arrangement, the audio communication between the user and the customer service system can include audio communication between the user and an interactive voice response system. In another arrangement, the audio communication between the user and the customer service system can include audio communication between the user and a customer service representative. In one arrangement, the digital signature can include a credit card number. In another arrangement, in addition to or in lieu of the credit card number, the digital signature can include a social security number, a maiden name, a date of birth, a name that is different than the user's name and/or a password. Responsive receiving by the content recognition system the digital signature, the digital signature can be processed to authenticate an identity of the user.

In another arrangement, a system also can include a processor programmed to initiate executable operations. In one aspect, the executable operations can include, during a telephone call session established over a telephonic communication channel between a first user communicating using a first communication device and at least a second entity, receiving by a content recognition system, executed by the processor, media content transmitted by the first communication device over the telephonic communication channel during the telephone call session, wherein audio communication between the first user and the second entity occurs over the telephonic communication channel in the telephone call session prior to and after the media content being transmitted. Thus, the media content can be communicated from one user to another without disrupting voice communications in the call session. Responsive to receiving by the content recognition system the media content, at least one event can be initiated.

In one aspect, the second entity can be a second user. Further, initiating at least one event can include transmitting the media content to a second communication device used by the second user participating in a conference call with the first user. Further, the first communication device can communicate in the conference call using a first communication protocol and the second communication device can communicate in the conference call using a second communication protocol. The second communication protocol can be different than the first communication protocol. In an arrangement, a cloud storage can be provisioned to provide a transient workspace. The transient workspace can be configured to store the media content, and the transient workspace can be configured to be accessed by at least the second entity to retrieve the media content from the transient workspace over the telephonic communication channel. In an arrangement, initiating at least one event can include parsing information from the media content and processing the information parsed from the media content to authenticate an identity of the first user. The information parsed from the media content can include a social security number, a credit card number, a maiden name, a date of birth, and/or a name that is different than the user's name. In an arrangement, initiating at least one event can include parsing a credit card number from the media content and processing the credit card number parsed from the media content to process payment for an order for a product or service requested by the first user.

A computer program includes a computer readable storage medium having program code stored thereon. The program code is executable by a processor to perform a method. The method can include during a telephone call session established over a telephonic communication channel between a user communicating using a first communication device and a customer service system, receiving by a content recognition system, executed by the processor, a digital signature transmitted by the first communication device during the telephone call session, the digital signature communicated over the telephonic communication channel used to support audio communication between the first communication device and the customer service system in the telephone call session. The method further can include processing the digital signature to authenticate an identity of the user. Thus, the user need not provide spoken utterances or multiple keystrokes for user authentication purposes.

### BRIEF DESCRIPTION OF THE DRAWINGS

FIG. 1 is a block diagram illustrating an example of a communication system.

FIG. 2 depicts an example of an electronic form presented by a user interface of a user device.

FIG. 3 is a flow diagram illustrating an example of transmitting media content over a telephonic communication channel.

FIG. 4 depicts another example of a view presented by a user interface of a user device.

FIG. 5 is a block diagram illustrating example architecture for a processing system hosting an intelligent content recognition system.

FIG. 6 is a block diagram illustrating example architecture for a user device.

FIG. 7 is a flow chart illustrating a method of receiving a digital signature over a telephonic communication channel.

FIG. 8 is a flow chart illustrating a method of receiving media content over a telephonic communication channel.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to electronic communications, and more specifically, to the exchange of information over a telephonic communication channel. In accordance with the inventive arrangements disclosed herein, a user who is participating in a telephone call session established over a telephonic communication channel can transmit, over the telephonic communication channel, media content while maintaining the telephone call session. For example, when calling into a customer service center, the user's call may first be directed an interactive voice response (IVR) system and the user may be asked to provide various types information to confirm the user's identity. Rather than manually entering the information via a keypad or speaking the information, which can be cumbersome, the user can transmit the requested information over the same telephonic communication channel on which the telephone call session is established. Moreover, the user need not terminate voice communications in order to send the information. In illustration, the user can select a particular key or button to initiate communication of a digital signature. The IVR system can process the digital signature in real time to confirm the user's identity. Accordingly, the identity of the user can be confirmed very quickly, and the user can be promptly transferred to the appropriate customer service representative. This improves the client experience of the user.

Further, while communicating with a customer service representative, the user may be asked to provide certain media content, for example, electronic forms, screen shots, audio, video, audio/video, etc. Rather than uploading the media content to a server or e-mailing the media content, in accordance with the arrangements described herein, the user can easily transfer the media content over the same telephonic communication channel on which the telephone call session is established. In illustration, the user can transmit a file including the media content over the telephonic communication channel. For example, a user can transmit a product image to indicate to the customer service representative a product the user is interested in purchasing. In another example, the user can capture a video illustrating an issue or problem the user is having, for instance with a recently purchased item, and transmit the video to the customer service representative. The customer service representative can view the video to help the user solve the issue or problem. In any case, the media content can be transmitted digitally on the telephonic communication channel using a modem, without terminating voice communication.

In another example, a user participating in a conference call can transmit media content to other users who also are participating in the conference call. Again, the media content can be transmitted over the same telephonic communication channel over which the user is participating in the conference call. The communication devices used by the other conference call participants can receive the media content and store the media content, display the media content, etc. Since the media content is transmitted over the telephonic communication channel, an external communication channel is not needed. For the user, this simplifies the process of participating in the conference call while still allowing the user to share media content with other conference call participants.

Moreover, the arrangements described herein allow for users to share media content, regardless of the particular communication protocols being used by the user's respective communication devices to participate in the conference call. For example, one user may be participating in the conference call using a mobile phone communicating via a mobile communication protocol, another user may be participating in the conference call using a telephone communicating via Voice over Internet Protocol (VoIP), and another user may be participating in the conference call using a traditional landline. Nonetheless, the arrangements described herein allow for the media content to be shared to all users. The media content can be transmitted to the communication devices used by the respective users using the appropriate communication protocols used by their respective communication devices to communicate, and without requiring secondary communication links to access the shared media content.

Several definitions that apply throughout this document now will be presented.

As defined herein, the term “telephone call session” means an audio communication session established over a telephonic communication channel.

As defined herein, the term “telephonic communication channel” means a communication channel configured to carry telephonic communications. A telephonic communication channel can be established over the public switched telephone network (PSTN), over one or more cellular communication networks and/or over the Internet (e.g., using VoIP).

As defined herein, the term “media content” means text, audio, image and/or video information, that conveys a meaning In the context of arrangements described herein and the claims that follow, metadata is not media content. In the context of arrangements described herein and the claims that follow, a caller ID (e.g., a caller identification (CID), a calling line identification (CLID), a calling number delivery (CND), a calling number identification (CNID), or a calling line identification presentation (CLIP)) is not media content.

As defined herein, the term “digital signature” means data unique to a particular caller and used to confirm the identity of the caller, wherein the data is contained in a file. A digital signature can be, for example, a digital certificate. In the context of arrangements described herein and the claims that follow, metadata is not a digital signature. In the context of arrangements described herein and the claims that follow, a caller ID (e.g., a caller identification (CID), a calling line identification (CLID), a calling number delivery (CND), a calling number identification (CNID), or a calling line identification presentation (CLIP)) is not a digital signature. In the context of arrangements described herein and the claims that follow, selection of one or more keys of a keypad by a caller do not constitute a digital signature, although a caller may select one or more keys to initiate transmission of a digital signature.

As defined herein, the term “customer service system” means a system that receives telephone calls from users (e.g., customers of an organization) configured to answer such telephone calls to interact with users regarding products and/or services provided by an organization. A customer service system may include an interactive voice response system and/or one or more client devices of the customer service system via which customer service representatives telephonically communicate with users.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “cloud storage” means a data storage scheme where data is stored in logical pools. The physical storage in cloud storage can span multiple data storage servers, which need not be co-located.

As defined herein, the term “real time” means a level of processing responsiveness that a user or system senses as sufficiently immediate for a particular process or determination to be made, or that enables the processor to keep up with some external process.

As defined herein, the term “user” means a person (i.e., a human being).

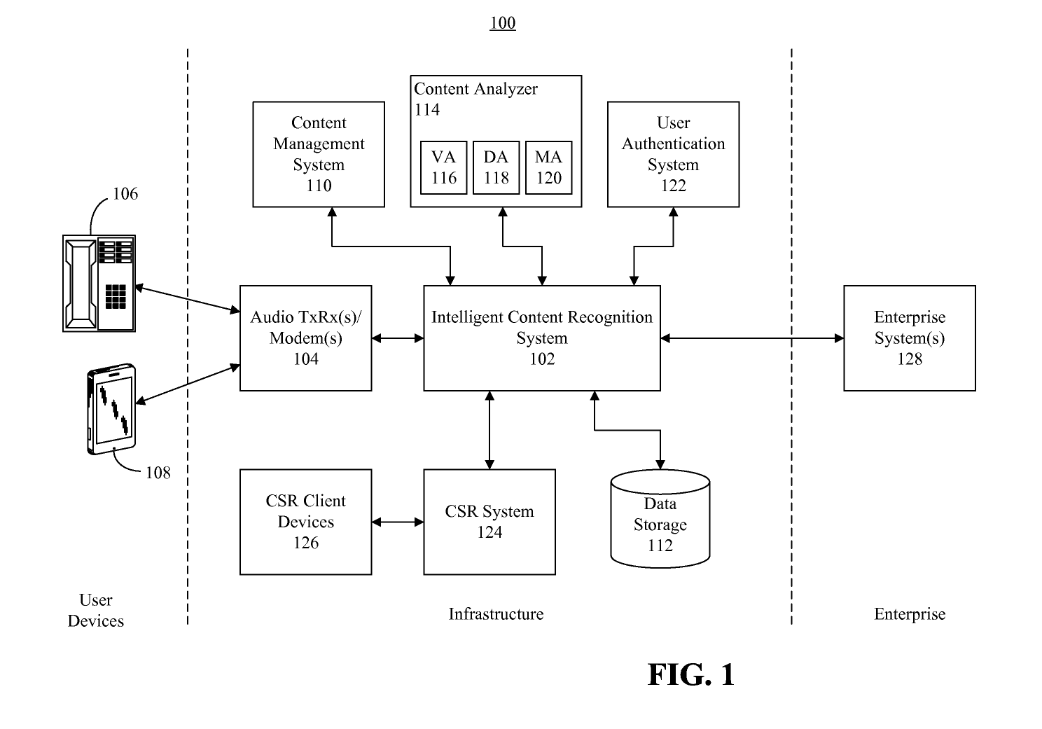

FIG. 1 is a block diagram illustrating an example of a communication system (hereinafter “system”) 100. The system can include an intelligent content recognition (ICR) system 102, which may be referred to herein and in the claims that follow as a content recognition system. The ICR system 102 can be implemented as an application or module executed by one or more processors (e.g., executed on a server). The ICR system 102 can be communicatively linked to one or more input/output (I/O) devices, such as one or more telephony transceivers configured to transmit and receive audio signals over a telephonic communication channel and one or more modems configured to transmit and receive digital data over a telephonic communication channel. For example, the system 100 can include an audio transceiver/modem module 104 that includes a plurality of audio transceivers and a plurality of modems. Telephony transceivers and modems are known to those skilled in the art. The ICR system 102 can be configured to receive and transmit, via the transceiver/modem module 104, voice signals, media content and digital signatures transmitted over telephonic communication channels. For example, the ICR system 102 can exchange voice signals, media content and/or digital signatures with one or more user devices 106, 108. The ICR system 102 also can be configured to interoperate with various components of the system 100, which will be described herein, to process the voice signals, media content and digital signatures.

The user devices 106, 108 are communication devices used to users to communicate over a telephonic communication channel. The user devices 106, 108 can be telephones, mobile phones, smart phones, personal digital assistants (PDAs), tablet computers, desktop computers, or any other devices configured to communicate audio information over a telephonic communication channel. In this regard, each the user devices 106, 108 can include at least one telephony transceiver, or a discrete audio transmitter and discrete audio receiver, configured to send and receive audio signals (e.g., voice signals) over telephonic communication channels. The telephonic communication channels can be standard telephonic communication channels established over the public switched telephone network (PSTN) and/or telephonic communication channels established using mobile communications.

For example, in an arrangement in which the user device 108 is a mobile phone, smart phone, PDA or tablet computer, the user device 108 can be configured communicate over a cellular communication network in accordance with a mobile communication protocol, such as 3G, 4G, LTE, GSM, etc. In an arrangement in which the user device 106 is a conventional telephone, the user device 106 can be configured to communicate via the PSTN. Further, the user device 106 can be operatively coupled to a modem configured to interface with the user device 106 to transmit and/or receive digital data over the PSTN during an established telephone call session. The user device 106 also can be operatively coupled to an external processing system and/or data storage device, which can store media content transmitted or received by the user device 106. The user device 106 can be operatively coupled directly to the modem and/or processing system directly using wired connections or using a wireless transceiver (e.g., a Bluetooth® or Wi-Fi™ transceiver).

The system 100 further can include a content management system 110. The content management system 110 can be implemented as an application or module executed by one or more processors (e.g., executed on a server). For example, the content management system 110 can be executed by one or more processors executing the ICR system 102, or executed by one or more other processors communicatively linked to the ICR system 102 via a suitable network. The content management system 110 can record all content, including media content and digital signatures, received by the ICR system 102. Such content can be received from user devices 106, 108 during telephone call sessions established between the user devices 106, 108 and the ICR system 102 over telephonic communication channels. Further, the content management system 110 can maintain a data repository in which such content is stored, for example in a data storage 112. In illustration, the content management system 110 can maintain a database for tracking and storing the content. Such data can be accessed, cross-referenced, etc., for user verification and to implement automated call services during the telephone call sessions. In one aspect, the data storage 112 can be cloud storage. The content management system 110 can be communicatively linked to the data storage 112 via the ICR system 102, directly linked to the data storage 112, or communicatively linked to the data storage 112 via one or more suitable networks.

The system 100 also can include a content analyzer 114. The content analyzer 114 can be implemented as an application or module executed by one or more processors (e.g., executed on a server). For example, the content analyzer 114 can be executed by one or more processors executing the ICR system 102, or executed by one or more other processors communicatively linked to the ICR system 102 via a suitable network. The content analyzer 114 can process media content from one or more user devices 106, 108. For example, responsive to the content management system 110 recording the media content, the ICR system 102 can communicate the media content to the content analyzer 114 or the ICR system 102 can communicate information to the content analyzer 114 which the content analyzer 114 may use to access the media content from the data storage 112.

The content analyzer 114 can include a voice analyzer 116, a document analyzer 118 and a multimedia analyzer 120. The voice analyzer 116 can be configured to perform speech recognition on incoming audio signals contained in the media content, or otherwise received by the ICR system 102, to generate text or other data representing spoken utterances contained in the audio signals. The content analyzer 114 can store the text or other data to the data storage 112. The content analyzer 114 also can communicate such text or other data to the ICR system 102 for additional analysis. Based on text or other data, the ICR system 102 can perform any of a variety of operations.

The document analyzer 118 and multimedia analyzer 120 can be configured to analyze media content received by the ICR system 102 via the modem(s) 104. For example, the document analyzer 118 can analyze media content in the form of documents (e.g., electronic forms, .pdf documents, text documents, and the like) received by the ICR system 102. The document analyzer 118 can parse information (e.g., text, images, etc.) from the documents and communicate the parsed information to the ICR system 102 for further analysis. The multimedia analyzer 120 can analyze media content received by the ICR system 102 in the form of multimedia files (e.g., audio files, video files, image files, audio/video files, etc.). Again, the multimedia analyzer 120 can parse information (e.g., text, images, audio, video, etc.) from the media content. The content analyzer 114 can store information parsed by the document analyzer 118 and multimedia analyzer 120 to the data storage 112. Further, the content analyzer 114 can communicate the parsed information to the ICR system 102 for further analysis

The system 100 also can include a user authentication system 122. The user authentication system 122 can be implemented as an application or module executed by one or more processors (e.g., executed on a server). For example, the content analyzer 114 can be executed by one or more processors executing the ICR system 102, or executed by one or more other processors communicatively linked to the ICR system 102 via a suitable network. In one arrangement, responsive to receiving a digital signature from one or more user devices 106, 108, the ICR system 102 can communicate the digital signature to the user authentication system 122. The user authentication system 122 can process the digital signature to authenticate the user who sent the digital signature. For example, the digital signature can include user identification information, such as a social security number, a credit card number, a maiden name, a date of birth, a name that is different than the user's name, a password and/or any other information that may be used to authenticate a user. In one arrangement, the digital signature can be a digital certificate issued by a central agency distinct from the system 100, though the invention is not limited in this regard.

The user authentication system can parse user identification information from the digital signature to authenticate the user. Thus, rather than prompting a user to enter or speak confidential information, such information can be provided in the digital signature, thereby providing the user a level of protection from eaves dropping. Responsive to the user authentication system 122 authenticating the user by processing the digital signature, the user authentication system 122 can communicate to the ICR system 102 an indicator indicating that the user has been authenticated. Responsive to the user authentication system 122 not being able to authenticate the user by processing the digital signature, the user authentication system 122 can communicate to the ICR system 102 an indicator indicating that the user has not been authenticated.

In another arrangement, rather than authenticating the user based on a digital signature, or in addition to authenticating the user based on the digital signature, the user authentication system 122 can authenticate the user based on information parsed from media content by the content analyzer 114. For example, responsive to receiving information parsed from a document, audio, image, video and/or multimedia from the content analyzer 114, the ICR system 102 can identify any such information that may be used to authenticate the user, and communicate such information to the user authentication system 122. Again, such information can include a social security number, a credit card number, a maiden name, a date of birth, a name that is different than the user's name, a password and/or any other information that may be used to authenticate a user. The user authentication system 122 can process such information, and based on such processing, communicate an indicator to the ICR system 102 indicating whether has been authenticated.

The system 100 also can include a customer service representative (CSR) system 124. The CSR system 124 can include one or more client devices 126 (e.g., workstations, desktop computers, tablet computers, smart phones, telephones, and the like) via which customer service representatives interact with users during telephone call sessions. In one non-limiting arrangement, the CSR system 124 further can include one or more servers configured to manage incoming calls to the CSR system 124. Such servers are known to those skilled in the art.

Telephone calls from users, for example users using the user devices 106, 108, to the CSR system 124 can be routed through, or monitored by, the ICR system 102. When the CSR system 124 requires user authentication for an incoming call, the CSR system 124 can prompt a user to choose whether to answer questions asked by the CSR system 124, to provide a digital signature, or to provide media content containing certain identification information. If the user chooses to provide a digital signature or to provide media content, the user can enter one or more user inputs to the user's communication device (e.g., user device 108) to transmit the digital signature or media content over the telephonic communication channel. The ICR system 102 and user authentication system 122 can process the digital signature or media content as described to authenticate the user. Once the user has been authenticated, the ICR system 102 can notify the CSR system 124, which can route the call to the appropriate customer service representative using a CSR client device 126.

The system 100 also can include one or more enterprise systems 128. The enterprise systems 128 can include one or more servers configured to execute enterprise applications used in a business environment, for example a customer loyalty system, marketing systems, business analytics systems, order management systems, inventory management systems, business rules engines, etc. These systems can provide a services layer and/or repository leveraged by the ICR system 102 to make intelligent decisions for servicing customers in an efficient manner. For instance, the ICR system 102 can invoke one or more enterprise systems 128 to process information parsed from media content received from users. In illustration, once important attributes about a user are obtained, the enterprise system 128 can determine a customer lifetime value score for the user and, based on the attributes and the customer lifetime value score, select services that may be applicable to, or offered to, the user. The enterprise system 128 can pass corresponding information to the CSR system 124. Thus, during a telephone call session with the user, a customer service representative can review the information and converse with the user about the various services.

In one arrangement, the enterprise systems 128 can include a teleconferencing system. The teleconferencing system can host teleconferences among a plurality of users using a plurality of user devices 106, 108. During a teleconference, users can communicate among one anther using voice communication, regardless of the communication protocols used by the communication devices to transmit and receive voice signals and media content. Further, a user of a communication device, for example the user device 108, can transmit media content to the ICR system 102 over the telephonic communication channel supporting the user's telephone call session with the teleconference. In one arrangement, responsive to receiving the media content, the ICR system 102 can initiate at least one event. For example, the ICR system 102 can present the media content to at least one other user participating in the teleconference. In illustration, the ICR system 102 can transmit the media content to one or more respective other user devices, for example the user device 106. The ICR system 102 can interface with the teleconferencing system to facilitate transmission of the media content, though the present arrangements are not limited in this regard. Notably, the communication of the media content need not be limited to a particular communication protocol. For example, the media content can be received from a first user using a first communication protocol, and transmitted to one or more other users user one or more other communication protocols. Further, if the user device 106 does not include a display, but is communicatively linked to a system that includes a display, the media content can be presented by such other system.

In another example, the event that is initiated can cause the content analyzer 114 to parse information from the media content. In this arrangement, the ICR system 102 can present the parsed information to one or more of the user's participating in the teleconference by communicating the parsed information to the users' communication devices in accordance with the communication protocols used by their respective user devices. Responsive to receiving the parsed information, the respective user devices can present the information. For example, the media content may contain text. The content analyzer 114 can parse the text from the media content, and the ICR system 102 can transmit the text, over the telephonic communication channel(s) supporting the user telephone call sessions, to one of more of the user devices 106, 108 to present the text on respective displays. In a further example, the media content may contain audio, images, and/or video. The audio, images and/or video can be parsed from the media content and transmitted to one or more of the user devices 106, 108 for presentation to respective users in a similar manner.

In illustration, each of the user devices 106, 108 can include an application or module configured to receive media content transmitted by other user devices 106, 108. For example, the application or module can be resident on the user device 108. The application or module also may be resident on a processing system to which the user device 106 is operatively coupled. Responsive to receiving media content, the application or module can present a notification alerting the respective user than the media content has been received. In the case that a plurality of different media content are received, the application or module can present each respective media content in a tab. The user can select the tab to imitate presentation of the media content. In another arrangement, the application or module can a list of media content that has been received, and the user can select a particular media content to be presented from the list.

Further, the ICR system 102 can store telephone call session data for the teleconference in the data storage 112, as well as media content shared during the teleconference. The user devices 106, 108 can be configured, via the aforementioned application or module, to interface with the ICR system 102 to access the telephone call session data at any time to access the shared media content. Thus, if during or some time after the teleconference a user desires to access the shared media content, the user is able to do so. In an arrangement in which the data storage 112 is a cloud storage, the ICR system 102 can provision the cloud storage to provide a transient workspace. The transient workspace can be configured to store media content shared during the teleconference. Further, the transient workspace can be configured to be accessed by the user devices 106, 108 to retrieve the media content from the transient workspace over the telephonic communication channel. The transient workspace can be closed or deleted responsive to a determination being made that media data stored in the transient workspace no longer needs to remain accessible to users.

Since the telephone call session data is stored to the data storage 112, the telephone call session data need not be maintained on the individual user devices 106, 108. Thus, the telephone call session data, including the media content, can be deleted from the user devices 106, 108 after the teleconference ends. This can help to reduce the amount of data stored on the user devices 106, 108. Nonetheless, on one arrangement, users can be given an option to save the telephone call session data and/or the media content on their respective user deices 106, 108.

Regardless of whether the media content is presented or information parsed from the media content is presented, the present arrangements allow for the media content to be transmitted during the telephone call session over established telephonic communication channels. Accordingly, users participating in the teleconference need not access other networks to transmit media content for use in the teleconference. Moreover, users may exchange voice communications prior to, during, and after, the media content being transmitted. Thus, the teleconference will not be disrupted due to use of the voice communication channel to transmit the media content. In illustration, digital data carrying the media content can be interspersed between voice communication signals so as not to interrupt conversation and allow users to converse while the data is being transmitted.

For example, if the telephone call session for a particular user device 106, 108 is established using Voice over Internet Protocol (VoIP) or a mobile communication protocol (e.g., 3G, 4G, LTE, GSM, etc.), data packets carrying the media content can be interspersed with data packets carrying voice signals. The user device 108 can, for example, execute an application or module that intersperses the data packets accordingly when transmitting media content, and distinguish audio data packets from media content data packets when receiving media content. In this regard, the header of each data packet can indicate the type of data contained therein. The application or module can distinguish the data packets based on the header information. Such application or module can be configured to interface with a standard telephone call application executing on the user device 108 to generate VoIP data or mobile communication data. The ICR system 102 can be configured in a similar manner to distinguish the different data packets and separate the voice signals from the media content as well. Further, digital signatures can be transmitted and received by the user device 108 and the ICR system 102 in a similar manner.

If the telephone call session for a particular user device 106 is established using a traditional telephone line, in one arrangement, digital signals carrying the media content can be coupled onto the telephone line using a modem that modulates the digital signals and couples the modulated digital signals onto the telephone line during pauses in the conversation. An application or module executing on the user device 106 can monitor voice signals and control operation of the modem to couple the digital signals accordingly. The application or module also can detect digital signals being received, and communicate those signals to the modem for demodulation. The ICR system 102 can be configured to operate similarly and, again, this technique can be applied to transmitting digital signatures as well.

In another arrangement, the application or module can digitize the voice signals and interface with the modem to modulate both the digitized voice signals and digital signals carrying the media content (or digital signature). The modem can couple the modulated signals on the telephone line when transmitting media content. When receiving media content, the modem can demodulate the received signals and separate the voice signals from the media content. Again, the ICR system 102 can be configured to operate similarly.

Regardless of the process used to transmit the media content over a standard telephone line, the present arrangements allow for the media content to be transmitted via the PSTN over the same telephonic communication channel used to communicate the voice signals in the telephone call session. This greatly simplifies the user experience when participating in a teleconference in which media content is shared. In this regard, the user need access the Internet or another network to transmit or receive the media content.

Still, various other operations can be performed by the system 100. The following examples illustrate some of these operations.

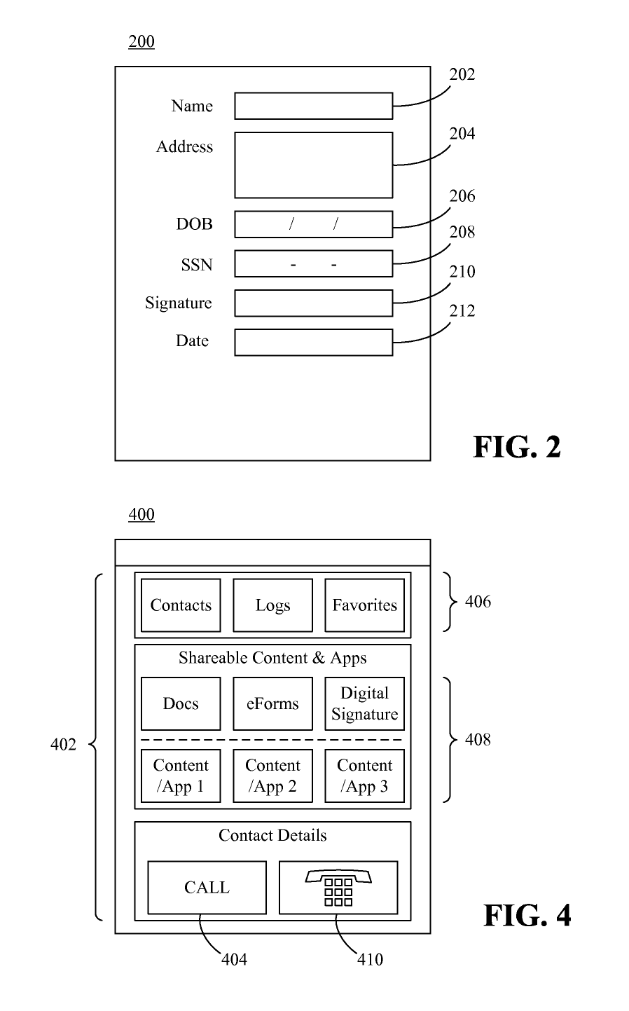

FIG. 2 depicts an example of an electronic form 200 presented by a user interface of a user device, such as the user device 108. The electronic form 200 can be transmitted to the user device 108 by the ICR system 102 when the user establishes a telephone call session with the ICR system 102, or the user can access download and fill out the electronic form 200 prior to establishing the telephone call session. In this example, the user can fill in the electronic form 200 with the user's information. For example, the user can enter the user's name in a field 202, the user's address in a field 204, the user's date of birth in a field 206 and the user's social security number in a field 208. The user also can provide an electronic signature in a field 210 and a date in a field 212. In one arrangement, the user can store the electronic form 200 on the user device 108. During the telephone call session, the user can select one or more keys, buttons, menu items, or the like on the user device 108 to transmit the electronic form 200 to the ICR system 102. As noted, the content analyzer 114 can parse the user information from the electronic form 200, and the user authentication system 122 can process the user information to authenticate the user. In another arrangement, rather than sending the electronic form 200, the user can send a digital signature for authentication purposes.

In some instances, the user may establish a telephone call session using a user device 106 which does not provide a user interface via which the user may complete the electronic form 200. Nonetheless, the user may fill out the electronic form 200 using another device, for example a computer (e.g., desktop computer, tablet computer, or the like), to which the user device 106 is communicatively linked via a wired or wireless connection. The computer can monitor the telephone call session. Responsive to the user selecting a particular key or button during the telephone call session, the computer can transmit the electronic form 200 over the telephonic communication channel carrying the telephone call session, for example using a modem connected to the telephone line. The computer also may transmit an electronic signature in a similar manner. Accordingly, an electronic form or electronic signature may be provided by the user to the ICR system 102 for user authentication, even if the user establishes a telephone call session using a device that, by itself, is not configured to transmit the electronic form or electronic signature.

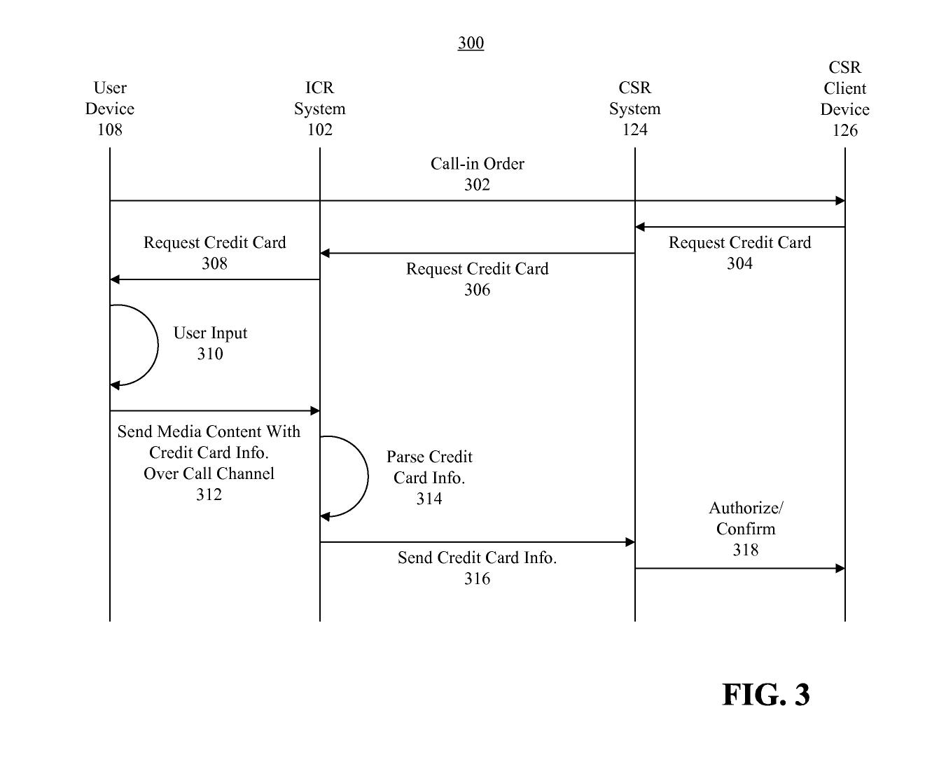

FIG. 3 is a flow diagram 300 illustrating an example of transmitting media content over a telephonic communication channel. In this example, during an established telephone call session, a user can transmit media content, or a digital signature, containing credit card information to pay for goods or services ordered over the telephone. At step 302, the user can place a call, via the user device 108, to an establishment providing the goods or services the user wishes to order. In illustration, the user can place a call to a restaurant to order food delivery. The call can be routed from the user device 108 to a customer service representative's client device 126 via the ICR system 102 and the CSR system 124. During the telephone call session, at step 304 the customer service representative can request credit card information to pay for the order. Such request can be routed to the CSR system 124 which can, at step 306, route the request to the ICR system 102. At step 308 the ICR system 102 can route the request to the user device 108 over the telephonic communication channel carrying the telephone call session. In one arrangement, in lieu of steps 304-308, the customer service can verbally request that the user provide credit card information.

In one non-limiting arrangement, the ICR system 102 also can transmit to the user device 108, over the telephonic communication channel carrying the telephone call session, an electronic form to be completed by the user with the user's credit card information. In another arrangement, the user may have an electronic form, a digital signature, or other media content containing such information. Regardless, at step 310 the user can enter a user input to the user device 108, for example by selecting a key, button menu item or providing a spoken utterance, to imitate transmission of the electronic form, digital signature, or other media content that includes the user's credit card information to the ICR system 102. At step 312, the electronic form, digital signature, or other media content can be transmitted from the user device 108 to the ICR system 102 over the telephonic communication channel carrying the telephone call session. At step 314, at the behest of the ICR system 102, the content analyzer 114 (shown in FIG. 1) can parse the credit card information from the electronic form, digital signature, or other media content. At step 316, the ICR system 102 can communicate the credit card information to the CSR system 124. The CSR system 124 can process payment of the order using the credit card information. Assuming the payment is authorized, at step 318 the CSR system 124 can notify the customer service representative, via the client device 126, that the payment is authorized and the order is confirmed. If the payment is not authorized, the CSR system 124 can notify the customer service representative accordingly.

Notably, during the process described, the user never need provide the user's credit card information to the customer service representative. Instead, the credit card information is provided to the ICR system 102 and CSR system 124. Thus, the risk of a customer service representative using the user's credit card information for unscrupulous purposes is mitigated. Moreover, the user can send the credit card information in a manner that does not require the user to present the information verbally, thereby mitigating the risk of others overhearing the information.

FIG. 4 depicts another example of a view 400 presented by a user interface of a user device (e.g., user device 108 of FIG. 1). In another arrangement, the view 400 can be presented by an operating system operatively coupled to a user device (e.g., the user device 106 of FIG. 1). The view 400 can be presented using an application or module specifically configured to present the view and implement process/events responsive to user inputs (e.g., selection of menu items), or can be presented using a web browser accessing a web site or web based application. The view 400 can present various menu items 402 selectable by a user of the user device.

The view 400 can present, for example, a menu item 404 which may be selected by a user to initiate a call to establish a telephone call session over a telephonic communication channel. The view 400 also can present menu items 406 which the user may select to access a list of contents, telephone call logs, favorite contacts and/or files, etc.

The view 400 further can present menu items 408 the user may select to choose documents, electronic forms, transactions and/or media content to transmit over the telephonic communication channel during the telephone call session. For example, the user can select a “Docs” menu item to select one or more documents to transmit during the telephone call session. Responsive to the user selecting the “Docs” menu item, a sub-menu (not shown) presenting a list of documents, for example documents contained in a particular directory, can be presented to the user. From that list, the user can select one or more documents. Once one or more documents are selected, the user can select from the sub-menu a menu item to initiate transmission of the selected document(s) to the ICR system 102, which can process the document in a suitable manner, for example as previously described, or transmit the document to other user devices via the ICR system 102. In one aspect, the sub-menu can provide options for the user to navigate to other directories and choose documents from one or more of the other directories. The menu items 408 further can include menu items the user may select to choose and transmit electronic forms, digital signatures, media content from various applications, and the like.

Further, the view 400 can present a menu item 410. The user may select the menu item 410 to activate a keypad. Via the keypad, the user can select numbers, text and/or symbols the user chooses to transmit during the telephone call session over the telephonic communication channel as media content. The ICR system 102 can communicate the text to CSR system 124 for presentation to a customer service representative, or transmit the text to one or more user devices 106, 108.

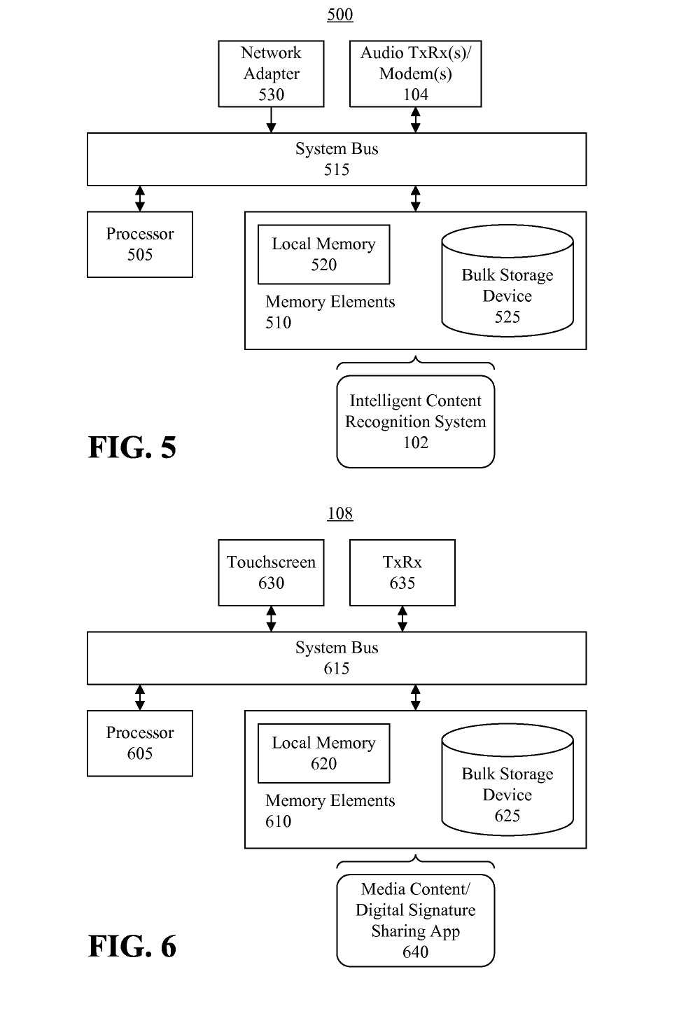

FIG. 5 is a block diagram illustrating example architecture for a processing system 500 hosting the ICR system 102. Optionally, the processing system 500 also can host the content management system 110, the content analyzer 114 and/or the user authentication system 122 of FIG. 1.

The processing system 500 can include at least one processor 505 (e.g., a central processing unit) coupled to memory elements 510 through a system bus 515 or other suitable circuitry. As such, the processing system 500 can store program code within the memory elements 510. The processor 505 can execute the program code accessed from the memory elements 510 via the system bus 515. It should be appreciated that the processing system 500 can be implemented in the form of any system including a processor and memory that is capable of performing the functions and/or operations described within this specification. For example, the processing system 500 can be implemented as a server.

The memory elements 510 can include one or more physical memory devices such as, for example, local memory 520 and one or more bulk storage devices 525. Local memory 520 refers to random access memory (RAM) or other non-persistent memory device(s) generally used during actual execution of the program code. The bulk storage device(s) 525 can be implemented as a hard disk drive (HDD), solid state drive (SSD), or other persistent data storage device. The processing system 500 also can include one or more cache memories (not shown) that provide temporary storage of at least some program code in order to reduce the number of times program code must be retrieved from the bulk storage device 525 during execution.

Input/output (I/O) devices can be coupled to the processing system 500. The I/O devices can be coupled to the processing system 500 either directly or through intervening I/O controllers. For example, one or more network adapters 530 can be coupled to processing system 500 to enable the processing system 500 to become coupled to other systems, computer systems, remote printers, and/or remote storage devices through intervening private or public networks. Further, the audio transceiver(s)/modem(s) 104 of FIG. 1 can be coupled to the processing system. As noted, the audio transceiver(s)/modem(s) 104 of FIG. 1 can be configured to transmit and receive voice signals, media content and digital signatures.

As pictured in FIG. 5, the memory elements 510 can store the components of the system 100 of FIG. 1, namely the ICR system 102 and, optionally, the content management system 110, the content analyzer 114. Being implemented in the form of executable program code, these components of the system 100 can be executed by the processing system 500 and, as such, can be considered part of the processing system 500. Moreover, the voice signals, media content and digital signatures processed by the ICR system 102 are functional data structures that impart functionality when employed as part of the processing system 500 of FIG. 5.

FIG. 6 is a block diagram illustrating example architecture for a user device, such as the user device 108 of FIG. 1. The user device 108 can include at least one processor 605 (e.g., a microprocessor) coupled to memory elements 610 through a system bus 615 or other suitable circuitry. As such, the user device 108 can store program code within the memory elements 610. The processor 605 can execute the program code accessed from the memory elements 610 via the system bus 615.

The memory elements 610 can include one or more physical memory devices such as, for example, local memory 620 and one or more bulk storage devices 625. The user device 108 also can include one or more cache memories (not shown) that provide temporary storage of at least some program code in order to reduce the number of times program code must be retrieved from the bulk storage device 625 during execution.

Input/output (I/O) devices such as a touchscreen 630 and a transceiver 635 can be coupled to the user device 108. The I/O devices can be coupled to the user device 108 either directly or through intervening I/O controllers. For example, the touchscreen 630 can be coupled to the user device 108 via a graphics processing unit (GPU), which may be a component of the processor 605 or a discrete device. One or more transceivers 635 also can be coupled to user device 108 to enable the user device 108 to become coupled to other systems, transmitting and receiving data, via a mobile communication network.

As pictured in FIG. 6, the memory elements 610 can store a media content/digital signature sharing application 640. Being implemented in the form of executable program code, these components of the media content/digital signature sharing application 640 can be executed by the user device 108 and, as such, can be considered part of the user device 108. Moreover, the voice signals, media content and digital signatures processed by the user device 108 are functional data structures that impart functionality when employed as part of the user device 108.

The user device 108 is but one example of numerous types of user devices that may be used in accordance with the inventive arrangements. For example, a conventional telephone operatively coupled to a modem and an external processing system. In such an arrangement, the media content/digital signature sharing application 640 can be executed by the processing system, which can selectively control operation of the telephone and a modem to send and receive media content and digital signatures, and present received media content to a user, while the user converses over the telephone.

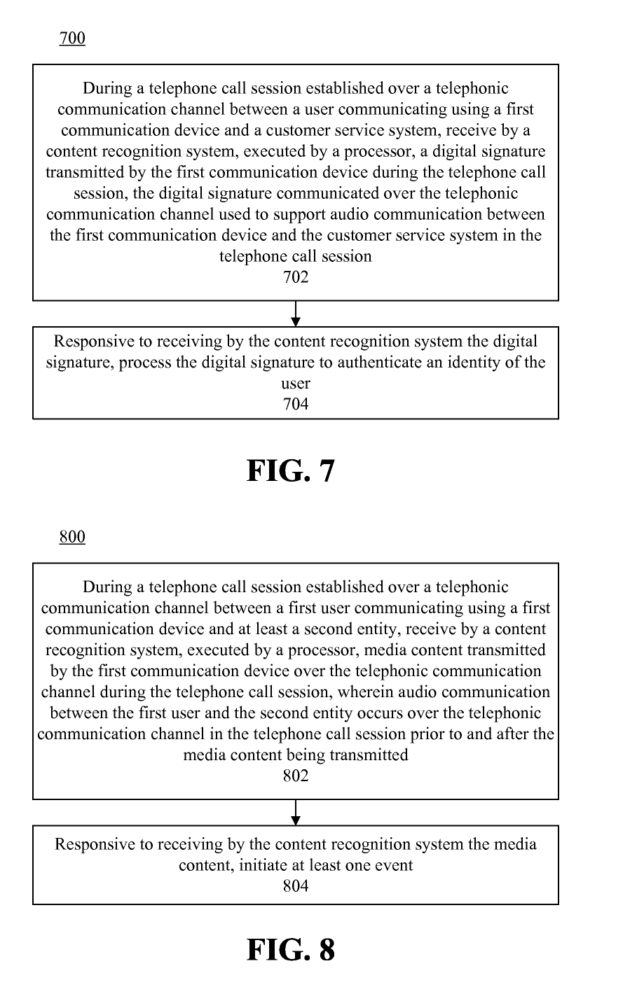

FIG. 7 is a flow chart illustrating a method 700 of receiving a digital signature over a telephonic communication channel. At step 702, during a telephone call session established over a telephonic communication channel between a user communicating using a first communication device and a customer service system, a digital signature transmitted by the first communication device during the telephone call session can be received by a content recognition system executed by a processor. The digital signature is communicated over the telephonic communication channel used to support audio communication between the first communication device and the customer service system in the telephone call session. In one arrangement, the audio communication between the user and the customer service system over the telephonic communication channel can occur in the telephone call session prior to and after the digital signature being transmitted. In one arrangement, the audio communication between the user and the customer service system can include audio communication between the user and an interactive voice response system. In another arrangement, the audio communication between the user and the customer service system can include audio communication between the user and a customer service representative. In one arrangement, the digital signature can include a credit card number. In another arrangement, in addition to or in lieu of the credit card number, the digital signature can include a social security number, a maiden name, a date of birth, a name that is different than the user's name and/or a password. At step 704, responsive receiving by the content recognition system the digital signature, the digital signature can be processed to authenticate an identity of the user.

FIG. 8 is a flow chart illustrating a method 800 of receiving media content over a telephonic communication channel. At step 802, during a telephone call session established over a telephonic communication channel between a first user communicating using a first communication device and at least a second entity, media content transmitted by the first communication device over the telephonic communication channel during the telephone call session can be received by a content recognition system executed by a processor. Audio communication between the first user and the second entity can occur over the telephonic communication channel in the telephone call session prior to and after the media content being transmitted. At step 804, responsive to receiving by the content recognition system the media content, at least one event can be initiated.

In one aspect, the second entity can be a second user. Further, initiating at least one event can include transmitting the media content to a second communication device used by the second user participating in a conference call with the first user. Further, the first communication device can communicate in the conference call using a first communication protocol and the second communication device can communicate in the conference call using a second communication protocol. The second communication protocol can be different than the first communication protocol.

In an arrangement, initiating at least one event can include parsing information from the media content and processing the information parsed from the media content to authenticate an identity of the first user. The information parsed from the media content can include a social security number, a credit card number, a maiden name, a date of birth, and/or a name that is different than the user's name.

In an arrangement, initiating at least one event can include parsing a credit card number from the media content and processing the credit card number parsed from the media content to process payment for an order for a product or service requested by the first user.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
during a telephone call session established over a telephonic communication channel between a user communicating using a first communication device and a customer service system, receiving by a content recognition system, executed by a processor, a digital signature transmitted by the first communication device during the telephone call session, the digital signature communicated over the telephonic communication channel used to support audio communication between the first communication device and the customer service system in the telephone call session; and
responsive to receiving by the content recognition system the digital signature, processing the digital signature to authenticate an identity of the user.

2. The method of claim 1, wherein the audio communication between the user and the customer service system over the telephonic communication channel occur in the telephone call session prior to and after the digital signature being transmitted.

3. The method of claim 1, wherein the audio communication between the user and the customer service system comprises audio communication between the user and an interactive voice response system.

4. The method of claim 1, wherein the audio communication between the user and the customer service system comprises audio communication between the user and a customer service representative.

5. The method of claim 1, wherein the digital signature comprises a credit card number.

6. The method of claim 1, wherein the digital signature comprises at least one type of information selected from a group consisting of a social security number, a maiden name, a date of birth, a name that is different than the user's name and a password.

7. A method, comprising:
during a telephone call session established over a telephonic communication channel between a first user communicating using a first communication device and at least a second entity, receiving by a content recognition system, executed by a processor, media content transmitted by the first communication device over the telephonic communication channel during the telephone call session, wherein audio communication between the first user and the second entity occurs over the telephonic communication channel in the telephone call session prior to and after the media content being transmitted; and
responsive to receiving by the content recognition system the media content, initiating at least one event.

8. The method of claim 7, wherein:
the second entity is a second user; and
initiating at least one event comprises transmitting the media content to a second communication device used by the second user participating in a conference call with the first user.

9. The method of claim 8, wherein the first communication device communicates in the conference call using a first communication protocol and the second communication device communicates in the conference call using a second communication protocol, wherein the second communication protocol is different than the first communication protocol;
the method further comprising provisioning a cloud storage to provide a transient workspace, the transient workspace configured to store the media content and the transient workspace configured to be accessed by at least the second entity to retrieve the media content from the transient workspace over the telephonic communication channel.

10. The method of claim 7, wherein initiating at least one event comprises:
parsing information from the media content; and
processing the information parsed from the media content to authenticate an identity of the first user.

11. The method of claim 10, wherein the information parsed from the media content comprises at least one type of information selected from a group consisting of a social security number, a credit card number, a maiden name, a date of birth, and a name that is different than the user's name.

12. The method of claim 7, wherein initiating at least one event comprises:
parsing a credit card number from the media content; and
processing the credit card number parsed from the media content to process payment for an order for a product or service requested by the first user.

13. A system, comprising:
a processor programmed to initiate executable operations comprising:
during a telephone call session established over a telephonic communication channel between a user communicating using a first communication device and a customer service system, receiving by a content recognition system, executed by the processor, a digital signature transmitted by the first communication device during the telephone call session, the digital signature communicated over the telephonic communication channel used to support audio communication between the first communication device and the customer service system in the telephone call session; and
processing the digital signature to authenticate an identity of the user.

14. The system of claim 13, wherein the audio communication between the user and the customer service system over the telephonic communication channel occur in the telephone call session prior to and after the digital signature being transmitted.

15. The system of claim 13, wherein the audio communication between the user and the customer service system comprises audio communication between the user and an interactive voice response system.

16. The system of claim 13, wherein the audio communication between the user and the customer service system comprises audio communication between the user and a customer service representative.

17. The system of claim 13, wherein the digital signature comprises a credit card number.

18. The system of claim 13, wherein the digital signature comprises at least one type of information selected from a group consisting of a social security number, a maiden name, a date of birth, a name that is different than the user's name and a password.

19. A system, comprising:
a processor programmed to initiate executable operations comprising:
during a telephone call session established over a telephonic communication channel between a first user communicating using a first communication device and at least a second entity, receiving by a content recognition system, executed by the processor, media content transmitted by the first communication device over the telephonic communication channel during the telephone call session, wherein audio communication between the first user and the second entity occurs over the telephonic communication channel in the telephone call session prior to and after the media content being transmitted; and
responsive to receiving by the content recognition system the media content, initiating at least one event.

20. The system of claim 19, wherein:
the second entity is a second user; and
initiating at least one event comprises transmitting the media content to a second communication device used by the second user participating in a conference call with the first user.

21. The system of claim 20, wherein the first communication device communicates in the conference call using a first communication protocol and the second communication device communicates in the conference call using a second communication protocol, wherein the second communication protocol is different than the first communication protocol;
the method further comprising provisioning a cloud storage to provide a transient workspace, the transient workspace configured to store the media content and the transient workspace configured to be accessed by at least the second entity to retrieve the media content from the transient workspace over the telephonic communication channel.

22. The system of claim 19, wherein initiating at least one event comprises:
parsing information from the media content; and
processing the information parsed from the media content to authenticate an identity of the first user.

23. The system of claim 22, wherein the information parsed from the media content comprises at least one type of information selected from a group consisting of a social security number, a credit card number, a maiden name, a date of birth, and a name that is different than the user's name.

24. The system of claim 19, wherein initiating at least one event comprises:
parsing a credit card number from the media content; and
processing the credit card number parsed from the media content to process payment for an order for a product or service requested by the first user.

25. A computer program product comprising a computer readable storage medium having program code stored thereon, the program code executable by a processor to perform a method comprising:
during a telephone call session established over a telephonic communication channel between a user communicating using a first communication device and a customer service system, receiving by a content recognition system, executed by the processor, a digital signature transmitted by the first communication device during the telephone call session, the digital signature communicated over the telephonic communication channel used to support audio communication between the first communication device and the customer service system in the telephone call session; and
processing the digital signature to authenticate an identity of the user.
